(19) United States
(12) Patent Application Publication
(10) Pub. No.: US 2009/0216401 A1
(43) Pub. Date: Aug. 27, 2009

(54) FEEDBACK LOOP ON DIAGNOSTIC PROCEDURE

(76) Inventors: Olav M. Underdal, Kalamazoo, MI (US); Harry M. Gilbert, Portage, MI (US); Oleksiy Portyanko, Kalamazoo, MI (US); Randy L. Mayes, Otsego, MI (US); Gregory J. Fountain, Kalamazoo, MI (US); William W. Wittliff, III, Gobles, MI (US)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/038,332

(22) Filed: Feb. 27, 2008

(51) Int. Cl. G01M 17/00

(52) U.S. Cl. 701/35

(57) ABSTRACT

A diagnostic system for a vehicle, includes a diagnostic tool including a first memory, receiving vehicle specific information and performing a diagnostic test on the vehicle, storing the test result in the first memory, and a second memory in communication with the diagnostic tool, storing the test result in the database, the second memory providing a feedback of the test result to the diagnostic tool by transferring the information on the database to the diagnostic tool, correlating the feedback information into the diagnostic test procedure of the diagnostic tool.

### TECHNICAL FIELD

The present disclosure relates generally to diagnostic equipment and method. More particularly, the present disclosure relates to diagnostic equipment and method that includes generated information that is fed back to the diagnostic for use and its diagnostic procedures.

### BACKGROUND OF THE DISCLOSURE

Onboard control computers have become prevalent in motor vehicles, but as safety, economy, and emissions requirements have continued to tighten, the systems of motor vehicles have not met the requirements set out in government regulations and the implicit demands of competitors' achievements. Successive generations of onboard control computers have acquired increasing data sensing and retention capability as the electronics have advanced.

Present external diagnostic and display apparatus, known as diagnostic tools, are commonly limited to reporting the data acquired by the onboard control computer itself. Increasingly, subtle subsystem failures in vehicles overload the ability of maintenance technicians, not simply to read the faults detected and stored by the diagnostic tools themselves, but to combine those readings with peripheral measurements and deduce corrective actions with both speed and accuracy.

Currently in the automotive industry, there are both stand alone and hand-held diagnostic testers or tools used in connection with motor vehicle maintenance and repair. For example, hand-held diagnostic tools have been used to trouble-shoot faults associated with vehicular control units. Diagnostic tools can detect faults based on Diagnostic Trouble Codes or DTCs that are set in the vehicle's onboard control computer. A DTC can be triggered and stored when there is a problem with the vehicle. A technician then retrieves the DTC using a diagnostic tool, repairs the associated problem and then deletes the DTC from the vehicle's computer.

Including and beyond diagnostic trouble codes, in general, diagnostic systems are used by technicians and professionals in virtually all industries to perform basic and advanced system testing functions. For example, in the automotive, trucking, heavy equipment and aircraft industries, diagnostic test systems provide for vehicle onboard computer fault or trouble code display as mentioned above, interactive diagnostics, multiscope and multimeter functions, and electronic service manuals. In the medical industry, diagnostic systems provide for monitoring body functions and diagnosis of medical conditions, as well as system diagnostics to detect anomalies in the medical equipment.

In many industries, diagnostic systems play an increasingly important role in manufacturing processes, as well as in maintenance and repair throughout the lifetime of the equipment or product. Some diagnostic systems are based on personal computer technology and feature user-friendly, menu-driven diagnostic applications. These systems assist technicians and professionals at all levels in performing system diagnostics on a real-time basis.

A typical diagnostic system includes a display on which instructions for diagnostic procedures are displayed. The system also includes a system interface that allows the operator to view real-time operational feedback and diagnostic information. Thus, the operator may view, for example, vehicle engine speed in revolutions per minute, or battery voltage during start cranking; or a patient's heartbeat rate or blood pressure. With such a system, a relatively inexperienced operator may perform advanced diagnostic procedures and diagnose complex operational or medical problems.

The diagnostic procedures for diagnostic systems of this sort are typically developed by experienced technical experts or professionals. The technical expert or professional provides the technical experience and knowledge required to develop complex diagnostic procedures. Thus, the efficacy of the diagnostic procedures, in particular the sequence in which the diagnostic procedures are performed, is highly dependent on the expertise of the technical expert or professional authoring the procedures.

The diagnostics systems record the failures of components detected during diagnostic sequences, but at present there is no way for this information to be integrated into the diagnostic systems that are in use. Therefore, there is no way to have to improve the diagnostic procedure and information by the very information that is recorded.

There is a need to provide enhanced diagnostic sequencing of test steps, based on up-to-date historical data and to improve locale-specific diagnosis of failed components. There is also a need to improve the quality of data being used by the diagnostic systems.

### SUMMARY OF THE DISCLOSURE

The foregoing needs are met, to a great extent, by the present disclosure, wherein in one aspect a technique and apparatus are provided that will allow a technician to use a diagnostic system to determine the nature of a problem, with the ability to integrate the information obtained by the diagnostic system back into the instructions within the diagnostic system. The present disclosure provides a feedback loop on the diagnostic procedure, thus providing enhanced efficiency and a greater reliability of the result.

In an aspect of the present disclosure, a diagnostic system for a vehicle, includes a diagnostic tool including a first memory, receiving vehicle specific information and performing a diagnostic test on the vehicle, storing the test result in the first memory, and a second memory in communication with the diagnostic tool, storing the test result in the database, the second memory providing a feedback of the test result to the diagnostic tool by transferring the information on the database to the diagnostic tool, correlating the feedback information into the diagnostic test procedure of the diagnostic tool.

The diagnostic system can also include a manufacturer facility receiving information from the database and modifying the information back to the database. The diagnostic system can also include a repair facility receiving information from the database and modifying the information back to the database. The diagnostic system can also include the database receiving customer feedback information by identifying the symptom of the vehicle not being repaired, the feedback information of the customer being transferred to the diagnostic tool for correlation with diagnostic procedures.

The diagnostic system can also include the database receiving external feedback information by identifying the symptom of the vehicle not being repaired, the external feedback information being transferred to the diagnostic tool for correlation with diagnostic procedures. The diagnostic system can also include the database including diagnostic test information with the fields of age of the component, region of failure and the vehicle. The diagnostic system can also include the second memory being separate from the diagnostic tool.

The diagnostic system can also include the second memory being integrated with the diagnostic tool. The diagnostic system can also include the database including a termination of a diagnostic session and manual completion of the diagnostics, with the manual completion of the diagnostics extending the logic of the diagnostic system.

The diagnostic system can also include the extension of the logic being provided after posting of a service bulletin for a certain period of time and receiving feedback from the service bulletin. The diagnostic system can also include the diagnostic tool receives feedback of design issues of the vehicle and recurring failures of the identified vehicle.

In another aspect of the disclosure, a method for a vehicle diagnostic, includes receiving vehicle specific information, performing a diagnostic test on the vehicle according to the vehicle specific information, storing the diagnostic test result, and providing a feedback of the diagnostic test result by correlating the feedback information into the diagnostic test procedure for the next diagnostic test of the vehicle.

In another aspect of the disclosure, a diagnostic system for a vehicle, includes a diagnostic means including a first memory means, receiving vehicle specific information and performing a diagnostic test on the vehicle, storing the test result in the first memory means, and a second memory means in communication with the diagnostic means, storing the test result in the database, the second memory providing a feedback of the test result to the diagnostic means by transferring the information on the database to the diagnostic means, correlating the feedback information into the diagnostic test procedure of the diagnostic means.

There has thus been outlined, rather broadly, certain embodiments of the disclosure in order that the detailed description thereof herein may be better understood, and in order that the present contribution to the art may be better appreciated. There are, of course, additional embodiments of the disclosure that will be described below and which will form the subject matter of the claims appended hereto.

In this respect, before explaining at least one embodiment of the disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present disclosure. It is important, therefore, that the claims be regarded as including such equivalent constructions insofar as they do not depart from the spirit and scope of the present disclosure.

### BRIEF DESCRIPTION OF THE DRAWINGS

FIG. 1 is a front view illustrating a connection between a vehicle and a diagnostic tool or personal computer according to an embodiment of the disclosure.

FIG. 2 is a diagram of the feedback loop of the diagnostic system.

FIG. 3 is a block diagram of the feedback loop of the diagnostic system.

FIG. 4 is an alternative block diagram of the diagnostic system.

FIG. 5 is a block diagram of the computer of FIG. 1.

FIG. 6 is a front view of the diagnostic tool of FIG. 1.

FIG. 7 is a block diagram of the components of the diagnostic tool of FIG. 6.

### DETAILED DESCRIPTION

The disclosure will now be described with reference to the drawing figures, in which like reference numerals refer to like parts throughout. An embodiment in accordance with the present disclosure provides an apparatus and method that will allow a user, such as a technician, to use diagnostic equipment to generate data and feedback the generated data back into the diagnostic procedure.

The related diagnostics systems record the failures of components detected during diagnostic sequences, but at present there is no way for this information to be integrated into the diagnostic systems that are already in use in the field. The advanced diagnostic function diagnostic system of the present disclosure provides enhanced diagnostic sequencing of test steps, based on up-to-date historical data. The advanced diagnostic function diagnostic system of the present disclosure also provides feedback to manufacturing and authoring personnel regarding failure patterns. In addition, the advanced diagnostic function diagnostic system of the present disclosure provides improved locale-specific diagnosis of failed components, etc.

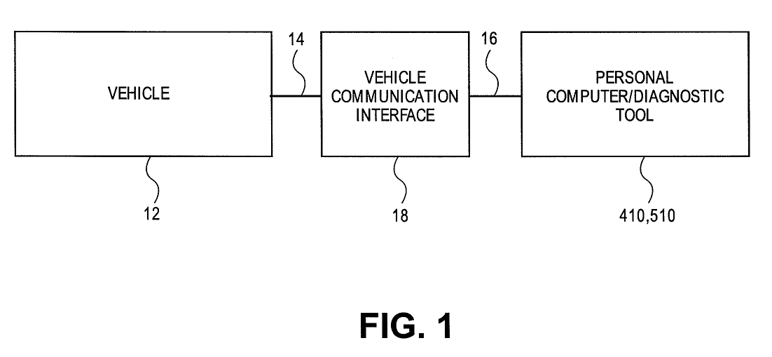

Referring to FIG. 1, a vehicle 12 is shown connected to a personal computer 410 or a dedicated diagnostic tool 510 via a vehicle communication interface 18. The first connection 14 between vehicle 12 and the vehicle communication interface 18, and the second connection 16 between the vehicle communication interface 18 and the personal computer/diagnostic tool 410 and 510 can be either wired or wireless.

Applicable communications with the host, such as a vehicle 12 connected to the unit, can be maintained during all functions of the vehicle during diagnostics. The connections 14 and 16 can include a wired connection such as through a RS232 port, USB (Universal Serial Bus), Ethernet cable. However, the connections 410 and 510 can also be wireless using protocols such as BLUETOOTH, IEEE 802.11x, wireless USB, other types of wireless Ethernet protocols, etc.

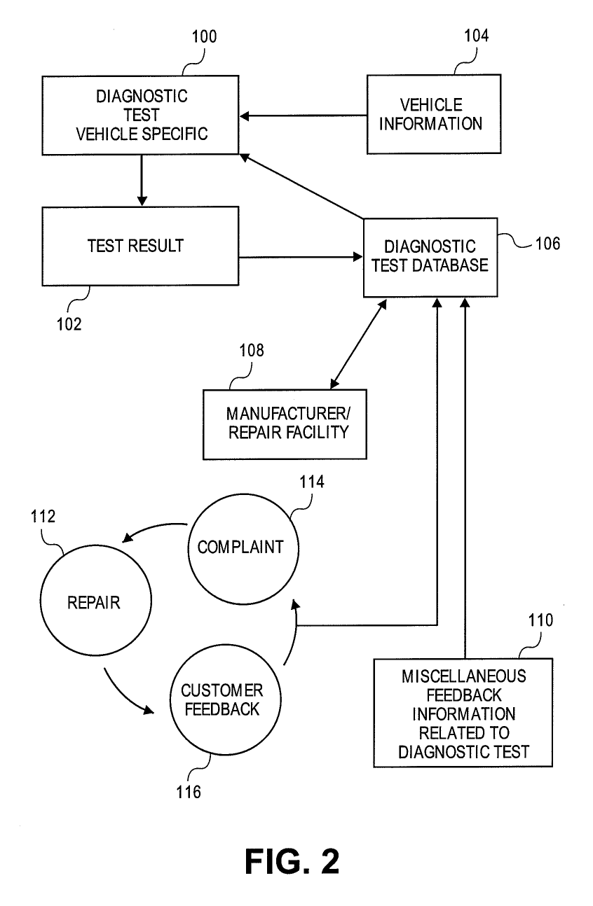

Referring to FIG. 2, as diagnostic results are recorded by an individual advanced diagnostic function diagnostic system installation, these results are pooled at one or more central locations, such as a diagnostic test database 106. From these locations, such as 106, statistically significant patterns in the diagnostic information, which would result in improved diagnostic test sequencing, are derived, and their relevant values made available to all subscribing advanced diagnostic function systems. Therefore, the database is not only in communication with one diagnostic system, but it can be a plurality of diagnostic systems.

These subscribing systems, such as computer 410 and diagnostic tool 510, would access the updated pool of diagnostic information from the database 106, to update their local diagnostics systems. The relevant information can include failure rates of components, locales at which some components fail more often than others, vehicle identity, age, etc., and also information associated with each component failure, etc.

The pool would be accessed by any number of means, including online network access, CD, DVD, or other access methods. Information feedback can include information provided by the user of the diagnostic tool. A customer feedback 116 from a repair 112 can include a negative feedback, such as a complaint 114, which results in another repair 112. The information from the customer can be sent to the diagnostic test database 106.

Specifically the user could feedback information that a diagnostic session was found to terminate without conclusion, with the user providing information on the resolution to the problem. This would happen if the diagnostic system was incomplete from a deductive logic point of view. This transaction would amount to an interactive extension of the diagnostic system.

The information provided by feedback would be captured by a central diagnostic author and used to re-author the particular part of the diagnostic procedures within the computer 410 or diagnostic tool 510. Such an extension could, for example, happen upon initial discovery in the field of a new problem. In such a case, feedback could be used to create a service bulletin, before a full extension of the diagnostic system would be provided.

Further, the user can provide information that a diagnostic session was found to terminate with a conclusion, with the user providing information to show that this original problem resolution was either incorrect or only partially correct. This would happen if the diagnostic system was either unsound or incomplete from a deductive logic point of view. This transaction would amount to an interactive modification or extension of the diagnostic system. The information provided by feedback would be captured by a central diagnostic author and used to re-author the particular part of the diagnostic procedures.

Moreover, information on usability or other general comments can be provided by the user. For example, there can be noting of design issues causing specific recurring failures in relation to the vehicles 12 being diagnosed, for feedback to the automotive manufacturer or repair facility 108, or noting issues with the functionality of the diagnostic tool 510 or computer 410.

Referring again to FIG. 2, the vehicle information can be inputted in 104 via a vehicle identification number (VIN) or other type of identification of the vehicle to ascertain the year, make and model, for example. The information for the vehicle is transferred to diagnostic tool 510 or computer 410 for a diagnostic test that is vehicle specific 100. The test result is then sent to the diagnostic test database 106.

The information from the test database is fed back to the diagnostic test 100 for modification of the test, if necessary. The information from the manufacturer and/or the repair facility 108 can also be added to the database for similar vehicles. Other miscellaneous feedback information related to the diagnostic test 110 can also be added to the diagnostic test database 106 for feedback to the advanced diagnostic function diagnostic system.

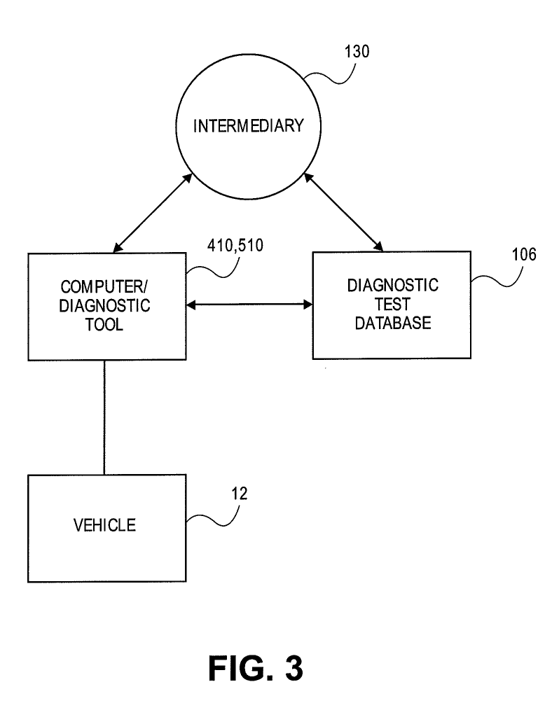

Referring to FIG. 3, an intermediary 130 can be used to feedback the information to the computer or diagnostic tool 410, 510. The intermediary can be, for example, the user that manually communicates or another device that automatically communicates or modifies the information from the diagnostic test database according to predetermined limitations. As seen in FIG. 3, the feedback loop is closed.

The intermediary 130 can also feedback the diagnostic test information from the database 106 to other diagnostic tools or computers. The database 106 can then obtain data from the plurality of diagnostic tools.

The feedback information can be grouped according to the computer or diagnostic tool 410, 510 that sent the original information and therefore, the information stored on the database 106 for a certain period of time is fed back to the same diagnostic tool 510 or computer. Alternatively, the information stored on the database 106 according to a certain method, where the information is accumulated or pooled, and is fed back to all the diagnostic tools receiving the information or subscribing to the information.

The grouping of the stored diagnostic information can be set according to certain conditions that are predetermined or they can be manually set. The intermediary 130 can funnel or filter the information being fed back to the computer/diagnostic tool 410, 510, or the filtering of the test database information can be filtered according to certain criteria on the computer/diagnostic tool 410, 510.

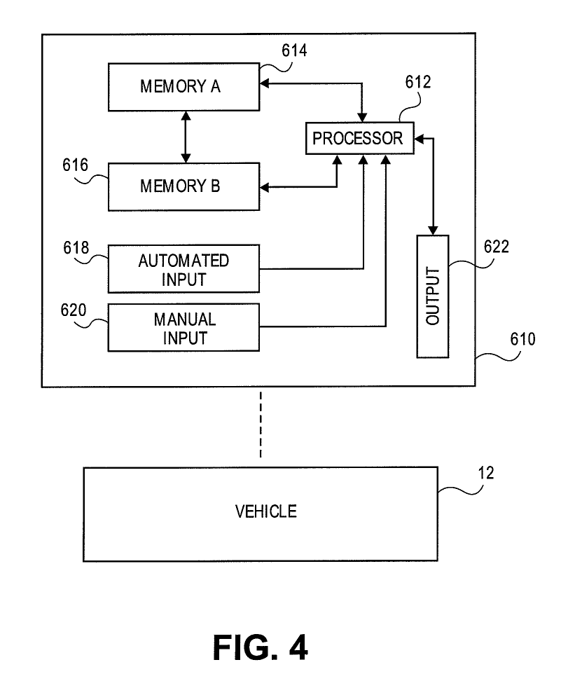

Referring to FIG. 4, alternatively, the test database can be stored in the advanced diagnostic function diagnostic device 610 itself. The diagnostic device 610 can include a processor executing the diagnostic tests and using memory A 614 for storage of the database for test diagnostics, instead of or in addition to the test diagnostic information stored on test database 106. The processor 612 runs the diagnostic software stored on memory B 616, and additional instructions can be manually inputted through input 620, including, for example, a button, or keyboard.

Alternatively, additional instructions can be entered through the automated input port 618. The information can be received from an external source, or information such as additional diagnostic testing information from the database 106 can append the information stored on memory A 614. The diagnostic information tested by the diagnostic device 610 can be outputted through port 622 to a display or even back to the database 106.

Referring back to FIG. 2, as an example, a user can consider the age of the component, region of failure, and vehicle being tested. The diagnostic database can include feedback to the manufacturer as seen in the transfer of information to the manufacturer 108. The advanced diagnostic function system is a closed loop as mentioned above and shown in FIG. 2. The diagnostic tool 510, can obtain, for example, the test result from the diagnostic test database 106. The test result is stored in the diagnostic database 106 in a certain format that is accessible by the diagnostic tool 510 or computer 410 for processing.

The user can enter information of the vehicle and any additional information that can customize and specify the data being stored in the diagnostic test database 106. If the VIN is entered in 104, then the age of the vehicle, make and model and other characteristics can be obtained from the VIN or other vehicle identification or the information can be manually inputted. The repair facility, along with the manufacturer 108 can enter the vehicle identification information at 104, or the user of the diagnostic system can enter the information. Then, the user runs through the diagnostic at 100. The user can check with the customer to see what customization they need. For example, the user can ask the customer whether he needs the repair, whether the component did or did not fix the problem, or if the customer notices additional problems, or whether the problem was fixed for only a certain period of time, or whether the problem took too long to fix. This information obtained from the customer is fed back from 116 to the user and the information is also fed back to the diagnosis test database 106.

The database 106 can include the negative feedback that the solution did not work well. Therefore, the history is taken into account to update the information on the database 106. As mentioned before, the customer feedback can be fed back as a complaint 114, then the repair 112 is made. The repair 112 makes a customer feedback in the loop of the diagnostic system, such that the diagnostic test database is updated and the information is relayed back to the diagnostic tool 510 or computer 410 for eventual update of its diagnostic process.

The statistical patterns that are obtained by the diagnostic system would be set to modify, for example the test sequencing based on the information fed back to the diagnostic tool 510. As an example, if it is shown that a certain component, such as sensor A, fails to correct the problem of symptom A, then the sequencing of the diagnostic device can be changed where sensor A is checked last. If however, there is feedback information that sensor A provides a positive result to the problem, then the sequence can be changed such that the sensor A is checked first in the sequencing of the testing.

The trial and error method of diagnosing a problem can be averted, by having a more intelligent system that includes a feedback of the information. In this manner, the sequencing of the testing is no longer arbitrary, but would have intelligence in the manner of diagnosis. If for example, the feedback information shows that part A will fail most of the time and is the cause of the symptom, then for reasons of efficiency of the diagnostic tests, part A will be checked first or more thoroughly, including, for example, additional tests on part A to make sure it is not the problem.

Criteria such as the locality of the component and respective results of certain localities can also be factored in. For example, if part A fails more often in Denver, and then the diagnostic tools located in Denver will obtain the filtered information based on the locality of Denver. A variety of other factors can also be included into the assembly and use of the feedback test diagnostic information from database 106.

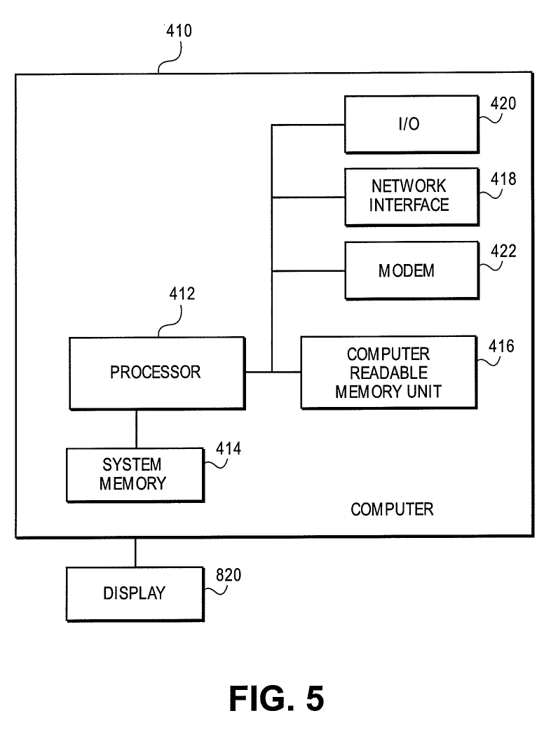

Referring to FIG. 5, an example of the computer 410 of FIG. 1, but not limited to this example of the computer 410, that can read computer readable media that includes computer-executable instructions of the disclosure. The computer 410 includes a processor 412 that uses the system memory 414 and a computer readable memory device 416 that includes certain computer readable recording media. A system bus connects the processor 412 to a network interface 418, modem 422 or other interface that accommodates a connection to another computer or network such as the Internet. The system bus may also include an input and output (I/O) interface 420 that accommodate connection to a variety of other devices. Furthermore, the computer 410 can output through, for example, the I/O 420, data for display on a display device 820.

The disclosure or parts thereof can be realized as computer-executable instructions in computer-readable media. The computer-readable media includes all possible kinds of media in which computer-readable data is stored or included or can include any type of data that can be read by a computer or a processing unit. The computer-readable media include for example and not limited to storing media, such as magnetic storing media (e.g., ROMs, floppy disks, hard disk, and the like), optical reading media (e.g., CD-ROMs (compact disc-read-only memory), DVDs (digital versatile discs), re-writable versions of the optical discs, and the like), hybrid magnetic optical disks, organic disks, system memory (read-only memory, random access memory), non-volatile memory such as flash memory or any other volatile or non-volatile memory, other semiconductor media, electronic media, electromagnetic media, infrared, and other communication media such as carrier waves (e.g., transmission via the Internet or another computer). Communication media generally embodies computer-readable instructions, data structures, program modules or other data in a modulated signal such as the carrier waves or other transportable mechanism including any information delivery media. Computer-readable media such as communication media may include wireless media such as radio frequency, infrared microwaves, and wired media such as a wired network. Also, the computer-readable media can store and execute computer-readable codes that are distributed in computers connected via a network. The computer readable medium also includes cooperating or interconnected computer readable media that are in the processing system or are distributed among multiple processing systems that may be local or remote to the processing system. The present disclosure can include the computer-readable medium having stored thereon a data structure including a plurality of fields containing data representing the techniques of the disclosure.

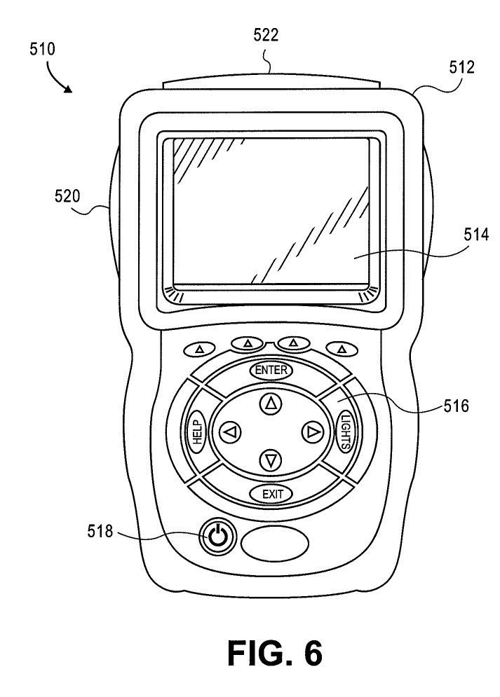

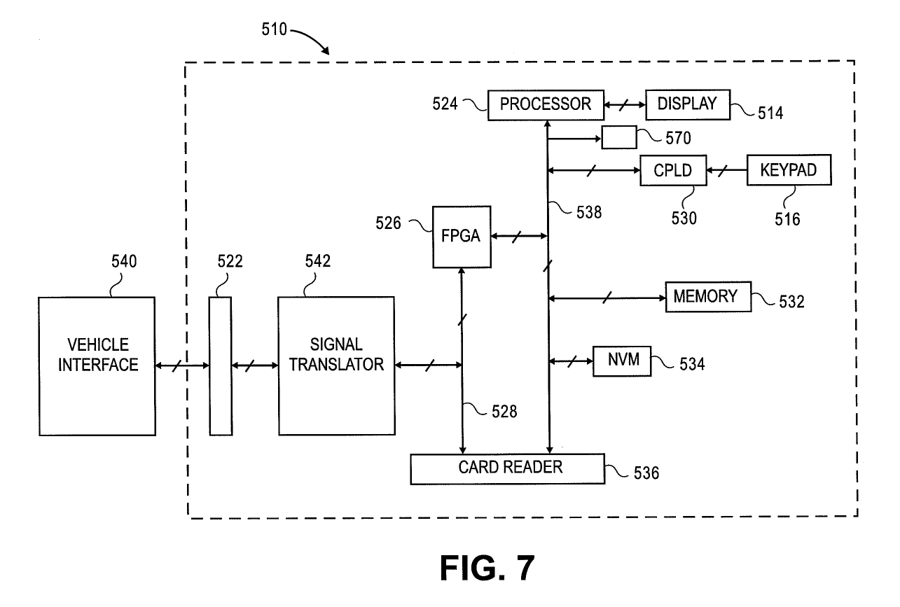

FIGS. 6-7 show the details of the diagnostic tool 510 of FIG. 1. Manufacturers have programmed their vehicle onboard computers with complicated methods of detecting a variety of problems. Further, the United States Environmental Protection Agency has mandated that DTCs be set where there are emissions related problems with the vehicle using the Onboard Diagnostic II System, also known as the OBD II system.

However, there are still problems of using the diagnostic tool since there are limitations in troubleshooting the actual cause of the functional anomaly of the diagnostic tool. A user is forced to look directly at the diagnostic tool's limited display that may display only the DTC or simple indicator of function being performed, and a message indicating a communication failure.

FIG. 6 is a front view illustrating a diagnostic tool 510 according to an embodiment of the disclosure. The diagnostic tool 510 can be any computing device, for example, the NEMISYS or GENISYS diagnostic tool from Service Solutions (part of the SPX Corporation) or other diagnostic tool. The diagnostic tool 510 includes a housing 512 to encase the various components of the diagnostic tool 510, such as a display 514, a user interface 516, a power button 518, a memory card reader 520 and a connector interface 522. The display 514 can be any type display, including, for example, but not limited to, a liquid crystal display (LCD), organic light emitting diode (OLED), field emission display (FED), electroluminescent display (ELD), etc. In addition, the LCD, for example, can be touch screen that both displays and performs the additional task of interfacing between the user and the diagnostic tool 510. The user interface 516 allows the user to interact with the diagnostic tool 510, in order to operate the diagnostic tool as the user prefers. The user interface 516 can include function keys, arrow keys or any other type of keys that can manipulate the diagnostic tool 510 in order to operate the diagnostic tool through the software. The user interface or input device 516 can also be a mouse or any other suitable input device for the user interface 516, including a keypad, touchpad, etc. The user interface 516 can also include keys correlating to numbers or alphanumeric characters. Moreover, as mentioned above, when the display 514 is touch sensitive, the display 514 can supplement or even substitute for the user interface 516. The power key or button 518 allows the user to turn the power to the diagnostic tool 510 on and off, as required.

A memory card reader 520 can be a single type card reader, such as, but not limited to, a compact flash card, floppy disk, memory stick, secure digital, flash memory or other type of memory. The memory card reader 520 can be a reader that reads more than one of the aforementioned memory such as a combination memory card reader. Additionally, the card reader 520 can also read any other computer readable medium, such as CD (compact disc), DVD (digital video or versatile disc), etc.

The connector interface 522 allows the diagnostic tool 510 to connect to an external device, such as, but not limited to, an ECU (electronic control unit) of a vehicle, a computing device, an external communication device (such as a modem), a network, etc. through a wired or wireless connection. Connector interface 522 can also include connections such as a USB (universal serial bus), FIREWIRE (Institute of Electrical and Electronics Engineers (IEEE) 1394), modem, RS232, RS48J, and other connections to communicate with external devices, such as a hard drive, USB drive, CD player, DVD player, or other computer readable medium devices.

FIG. 7 is a block diagram of the components of a diagnostic tool 510. In FIG. 6, the diagnostic tool 10, according to an embodiment of the disclosure, includes a processor 524, a field programmable gate array (FPGA) 526, a first system bus 528, the display 514, a complex programmable logic device (CPLD) 530, the user interface 516 in the form of a keypad, a memory subsystem 532, an internal non-volatile memory (NVM) 534, a card reader 536, a second system bus 538, the connector interface 522, and a selectable signal translator 542. A vehicle communication interface 540 is in communication with the diagnostic tool 510 through connector interface 522 via an external cable. The connection between the vehicle communication interface 540 and the connector interface 522 can also be a wireless connection such as BLUETOOTH, infrared device, wireless fidelity (WiFi, e.g. 802.11), etc.

The selectable signal translator 542 communicates with the vehicle communication interface 540 through the connector interface 522. The signal translator 542 conditions signals received from a motor vehicle control unit through the vehicle communication interface 540 to a conditioned signal compatible with the diagnostic tool 510. The translator 542 can communicate with, for example, the communication protocols of J1850 signal, ISO 9141-2 signal, communication collision detection (CCD) (e.g., Chrysler collision detection), data communication links (DCL), serial communication interface (SCI), S/F codes, a solenoid drive, J1708, RS232, controller area network (CAN), or other communication protocols that are implemented in a vehicle.

The circuitry to translate a particular communication protocol can be selected by the FPGA 526 (e.g., by tri-stating unused transceivers) or by providing a keying device that plugs into the connector interface 522 that is provided by diagnostic tool 510 to connect diagnostic tool 510 to vehicle communication interface 540. Translator 542 is also coupled to FPGA 526 and the card reader 536 via the first system bus 528. FPGA 526 transmits to and receives signals (i.e., messages) from the motor vehicle control unit through the translator 542.

FPGA 526 is coupled to the processor 524 through various address, data and control lines by the second system bus 538. FPGA 526 is also coupled to the card reader 536 through the first system bus 528. Processor 524 is also coupled to the display 514 in order to output the desired information to the user. The processor 524 communicates with the CPLD 530 through the second system bus 538. Additionally, the processor 524 is programmed to receive input from the user through the user interface 516 via the CPLD 530. The CPLD 530 provides logic for decoding various inputs from the user of diagnostic tool 510 and also provides the glue-logic for various other interfacing tasks.

Memory subsystem 532 and internal non-volatile memory 534 are coupled to the second system bus 538, which allows for communication with the processor 524 and FPGA 526. Memory subsystem 532 can include an application dependent amount of dynamic random access memory (DRAM), a hard drive, and/or read only memory (ROM). Software to run the diagnostic tool 510 can be stored in the memory subsystem 532. The internal non-volatile memory 534 can be, but not limited to, an electrically erasable programmable read-only memory (EEPROM), flash ROM, or other similar memory. The internal non-volatile memory 534 can provide, for example, storage for boot code, self-diagnostics, various drivers and space for FPGA images, if desired. If less than all of the modules are implemented in FPGA 526, the non-volatile memory 534 can contain downloadable images so that FPGA 526 can be reconfigured for a different group of communication protocols.

Although examples of the diagnostic system with a feed back loop is shown, other examples can also be made. For example, the partition or the location of the database 106 can varied. The database 106 can be stored in a variety of computer readable media described above. The feedback path can also be varied, by including for example additional feedback paths.

The many features and advantages of the disclosure are apparent from the detailed specification, and thus, it is intended by the appended claims to cover all such features and advantages of the disclosure which fall within the true spirit and scope of the disclosure. Further, since numerous modifications and variations will readily occur to those skilled in the art, it is not desired to limit the disclosure to the exact construction and operation illustrated and described, and accordingly, all suitable modifications and equivalents may be resorted to, falling within the scope of the disclosure.

What is claimed is:

1. A diagnostic system for a vehicle, comprising:
a diagnostic tool configured to receiving vehicle specific information and performing a diagnostic test on the vehicle, and storing the test result in a first memory; and
a second memory in communication with the diagnostic tool, and storing the test result in a database, the second memory providing a feedback of the test result to the diagnostic tool by transferring the information on the database to the diagnostic tool, correlating the feedback information into the diagnostic test procedure of the diagnostic tool.

2. The diagnostic system of claim 1, further comprising a manufacturer or dealer facility receiving information from the database and modifying the information back to the database.

3. The diagnostic system of claim 1, further comprising a repair facility receiving information from the database and modifying the information back to the database.

4. The diagnostic system of claim 1, further comprised of the database receiving customer feedback information by identifying the symptom of the vehicle not yet repaired, the feedback information of the customer being transferred to the diagnostic tool for correlation with diagnostic procedures.

5. The diagnostic system of claim 1, further comprised of the database receiving external feedback information by identifying the symptom of the vehicle not yet repaired, the external feedback information being transferred to the diagnostic tool for correlation with diagnostic procedures.

6. The diagnostic system of claim 1, further comprising database including diagnostic test information with the fields of age of the component, region of failure and the vehicle.

7. The diagnostic system of claim 1, the second memory being separate from the diagnostic tool and located on the remote device.

8. The diagnostic system of claim 1, wherein the second memory being integrated with the diagnostic tool.

9. The diagnostic system of claim 1, wherein the database including a termination of a diagnostic session and manual completion of the diagnostics, with the manual completion of the diagnostics extending a logic of the diagnostic system.

10. The diagnostic system of claim 1, wherein an extension of the logic being provided after posting of a service bulletin for a certain period of time and receiving feedback from the service bulletin.

11. The diagnostic system of claim 1, wherein the diagnostic tool receives feedback of design issues of the vehicle and recurring failures of the identified vehicle.

12. A method for a vehicle diagnostics, comprising:
receiving vehicle specific information;
performing a diagnostic test on the vehicle according to the vehicle specific information;
storing the diagnostic test result; and
providing a feedback of the diagnostic test result by correlating the feedback information into the diagnostic test procedure for the next diagnostic test of the vehicle.

13. The method of claim 12, further comprising receiving, by a manufacturer facility, information from the database and modifying the information back to the database.

14. The method of claim 12, further comprising receiving, by a repair facility, information from the database and modifying the information back to the database.

15. The method claim 12, further comprised of receiving customer feedback information by identifying the symptom of the vehicle to be repaired, the feedback information of the customer being transferred to the diagnostic to for correlation with diagnostic procedures.

16. The method of claim 12, further comprised of the receiving external feedback information by identifying the symptom of the vehicle to be repaired, the external feedback information being transferred for correlation with diagnostic procedures.

17. The method of claim 12, further comprising a database including diagnostic test information with the fields of age of the component, region of failure and the vehicle.

18. The method of claim 12, further wherein has a meaning of throwing away the second memory being separate from the diagnostic tool.

19. The method of claim 12, wherein the memory being integrated with the diagnostic tool.

20. The method of claim 12, wherein the feedback information including a termination of a diagnostic session and manual completion of the diagnostics, with the manual completion of the diagnostics extending a logic of the diagnostic system.

21. The method of claim 12, wherein an extension of the logic being provided after posting of a service bulletin for a certain period of time and receiving feedback from the service bulletin.

22. The method of claim 12, further comprised of receiving feedback of design issues of the vehicle and recurring failures of the identified vehicle.

23. A diagnostic system for a vehicle, comprising:
a diagnostic means including a first memory means, receiving vehicle specific information and performing a diagnostic test on the vehicle, storing the test result in the first memory means; and
a second memory means in communication with the diagnostic means, storing the test result in the database, the second memory providing a feedback of the test result to the diagnostic means by transferring the information on the database to the diagnostic means, correlating the feedback information into the diagnostic test procedure of the diagnostic means.

24. The diagnostic system of claim 23, further comprising a means for receiving information from a dealer or manufacturer from the database and modifying the information back to the database.

25. The diagnostic system of claim 23, further comprising a means for receiving information from a repair facility from the database and modifying the information back to the database.
